(19) United States
(12) Patent Application Publication
(10) Pub. No.: US 2010/0303191 A1
(43) Pub. Date: Dec. 2, 2010

(54) DRY STORAGE OF SPENT NUCLEAR FUEL

(75) Inventors: JAU-TYNE YEH, Taoyuan County (TW); TA-LUN SUNG, Taoyuan County (TW); CHUNG-HSING HU, Taoyuan County (TW); SHYUN-JUNG YAUR, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/561,331

(22) Filed: Sep. 17, 2009

(30) Foreign Application Priority Data
May 27, 2009 (TW) 098117677

(51) Int. Cl. G21C 19/00

(52) U.S. Cl. 376/272

(57) ABSTRACT

A dry storage of nuclear fuel is disclosed, which comprises: a plurality of nuclear fuel bundles, being arranged in a tight formation; a dry storage canister, formed with a cavity inside to be used for storing the plural nuclear fuel bundles; wherein the cavity is formed with a plurality of blocks of different heights at the top and bottom thereof that each of the blocks on the top and bottom are provided for one of the plural nuclear fuel bundles to mounted fixedly thereon for enabling any neighboring nuclear fuel bundles in the tight formation to be ruggedly arranged with different heights.

### FIELD OF THE INVENTION

The present invention relates to a dry storage nuclear fuel, and more particularly, to a dry storage canister capable of arranging the nuclear fuel bundles stored therein in a rugged formation of different heights for reducing flux and effective multiplication factor of neutrons and thus causing the nuclear critical safety of the dry storage canister to be enhanced.

### BACKGROUND OF THE INVENTION

The production of greenhouse gases and potential climate change is a problem of global proportion. Man's use of energy, especially in industrial activity with fossil fuel burning that emits gases containing carbon dioxide, is thought by most experts to be the major contributor to greenhouse effect responsible for climate change. Thus, people all over the world are searching for alternative energies as they are aiming to live in a greener and more energy efficient lives. Among those available alternative energies, as nuclear power can provide energy in a manner which contributes very little to the greenhouse effect, it will necessarily play a greater role in our lives in the future. However, there are still many details and operations in the nuclear power generation required to be improved for safety.

As the spent nuclear fuel, being the bi-product of nuclear power plant, is a high-level radioactive waste, the associated spent fuel disposal problem is a very challenging one, especially in terms of public acceptance of the final disposal site. Owing to the limited natural energy resources in Taiwan, the electricity generated from nuclear power plants is an important energy supply for domestic economic development. Presently, Taiwan Power Company has conducted a long-term disposal program for the spent nuclear fuel conforming to international regulations, which includes the following three processes: water-cooling, dry storage, and final disposal. In the performing of the second process, i.e. the dry storage, the spent nuclear fuel is stored and sealed in a metal canister so as to enable the decay heat generated by the decay of radionuclide in spent nuclear fuel to be dissipated by the natural convention, and then the metal canister is disposed inside concrete block for shielding radiation.

For improving nuclear safety, the design of the aforesaid dry storage canister must take the critical safety problem relating to neutrons in spent nuclear fuel as well as heat dissipating problem into consideration. That is, the dry storage canister should be designed for arranging the spent fuel bundles stored therein in a formation conforming to international regulations. Please refer to FIG. 1 and FIG. 2, which are schematic diagrams showing respectively a conventional spent fuel bundle and a plurality of spent fuel bundles in a conventional formation as they are stored in a conventional dry storage canister. As shown in FIG. 1 and FIG. 2, by lining up the plural spent fuel bundles 11 in a neat formation 2, the group of the plural spent fuel bundles 11 can be fitted and stored easily inside the dry storage canister. However, such neat formation 2 may not be the optimal formation regarding to nuclear fuel storage safety that should be improved.

### SUMMARY OF THE INVENTION

In view of the disadvantages of prior art, the object of the present invention is to provide a dry storage of nuclear fuel capable of arranging the nuclear fuel bundles stored therein in an improved formation for narrowing the distances between any two nuclear fuel bundles in the formation while meeting the optical safety requirement. In an embodiment, the present invention provides a dry storage canister capable of arranging the nuclear fuel bundles stored therein in a rugged formation of different heights for reducing flux and effective multiplication factor of neutrons and thus causing the nuclear critical safety of the dry storage canister to be enhanced.

To achieve the above object, the present invention provides a dry storage of nuclear fuel, which comprises: a plurality of nuclear fuel bundles, being arranged in a tight formation; a dry storage canister, formed with a cavity inside to be used for storing the plural nuclear fuel bundles; wherein the cavity is formed with a plurality of blocks of different heights at the top and bottom thereof that each of the blocks on the top and bottom are provided for one of the plural nuclear fuel bundles to mounted fixedly thereon for enabling any neighboring nuclear fuel bundles in the tight formation to be ruggedly arranged with different heights.

Preferably, the blocks relating to the nuclear fuel bundles in the odd-numbered rows or columns of the formation are formed of a same specific height for aligning the odd-numbered nuclear fuel bundles to each other at the same height while the blocks relating to the nuclear fuel bundles in the even-numbered rows or columns of the formation are formed of another same specific height for aligning the even-numbered nuclear fuel bundles to each other at the same height.

Preferably, the plural blocks are substantially a grouping of high blocks and low blocks arranged in a chessboard-like array in a manner that any one high block is surrounded by low blocks and any one low block is surrounded by high blocks.

Preferably, the height difference between neighboring nuclear fuel bundles is ranged between 3 inches to 12 inches.

Preferably, the dry storage canister is made of a metal.

Preferably, each of the plural nuclear fuel bundle is a fuel bundle selected from the group consisting of: a spent nuclear fuel bundle and an unused nuclear fuel bundle.

Preferably, the dry storage canister is received inside a metal container.

Preferably, the dry storage canister is stored on a rack in a transverse manner along with its container.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a conventional spent fuel bundle.

FIG. 2 is a schematic diagram showing a plurality of spent fuel bundles in a conventional formation as they are stored in a conventional dry storage canister.

FIG. 3 shows how the plural fuel bundles can be arranged ruggedly with different heights in a dry storage of nuclear fuel of the invention.

FIG. 4 shows a dry storage of nuclear fuel according to an embodiment of the invention.

FIG. 5 is a schematic diagram showing how a dry storage of nuclear fuel of the invention is stored.

FIG. 6 is a schematic diagram showing how blocks are formed on the top and bottom in the cavity of a dry storage of nuclear fuel according to a first embodiment of the invention.

FIG. 7 is a schematic diagram showing how blocks are formed on the top and bottom in the cavity of a dry storage of nuclear fuel according to a second embodiment of the invention.

FIG. 8 is a schematic diagram showing how blocks are formed on the top and bottom in the cavity of a dry storage of nuclear fuel according to a third embodiment of the invention.

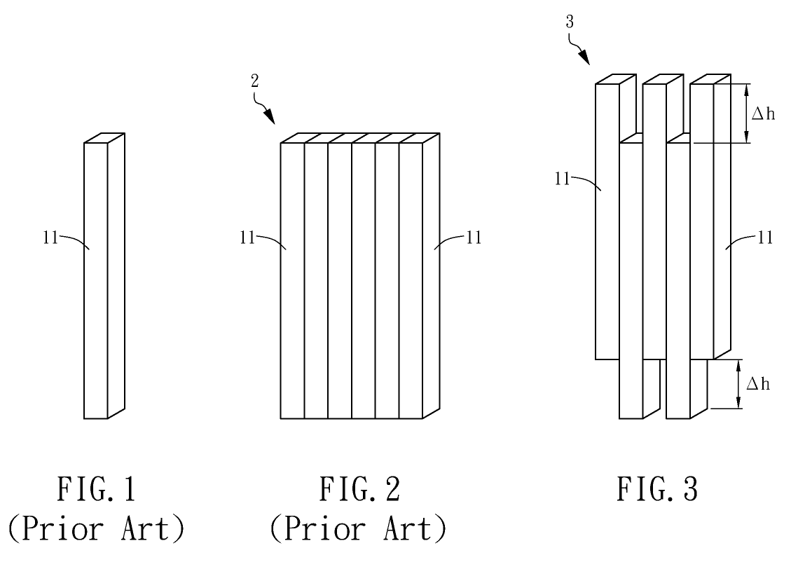

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

Please refer to FIG. 3, which shows how the plural fuel bundles can be arranged ruggedly with different heights in a dry storage of nuclear fuel of the invention. In FIG. 3, there is a plurality of nuclear fuel bundles 11 being lined up in a rugged formation 3 with a height difference Δh ranged between 3 inches to 12 inches. It is noted that when the height difference Δh is too large, the rugged formation 3 of the plural nuclear fuel bundles may not be received inside the dry storage canister easily and thus a larger canister may be required; on the other hand, when the height difference Δh is too small, the requirement matching nuclear critical safety may not be achieved.

The following description is related to critical condition in neutron behavior for illustrating the aforesaid rugged formation 3 with height difference Δh can achieve higher nuclear critical safety. The effective multiplication factor (k_{eff}), which is defined as the ratio of the neutrons produced by fission in one generation to the number of neutrons in the preceding generation. So, the value of k_{eff} for a self-sustaining chain reaction of fissions, where the neutron population is neither increasing nor decreasing, is one. The condition where the neutron chain reaction is self-sustaining and the neutron population is neither increasing nor decreasing is referred to as the critical condition and can be expressed by the simple equation k_{eff}=1. On the other hand, when k_{eff}<1, it is referred as subcritical condition whereas flux decreases each generation; and when k_{eff}>1, it is referred as supercritical condition whereas the neutron flux increases each generation indicating that the nuclear reaction might not be able to stop. Therefore, for achieving nuclear safety, the value of k_{eff} should be restricted. Moreover, as k_{eff} is closely related to the density of neutrons being produced in the fission, the arranging of the fuel bundle in the rugged formation of height difference is able to cause the density of neutrons distributed on the top and bottom of the storage canister to drop and thus cause the value of k_{eff} to reduce so as to enhance the nuclear safety.

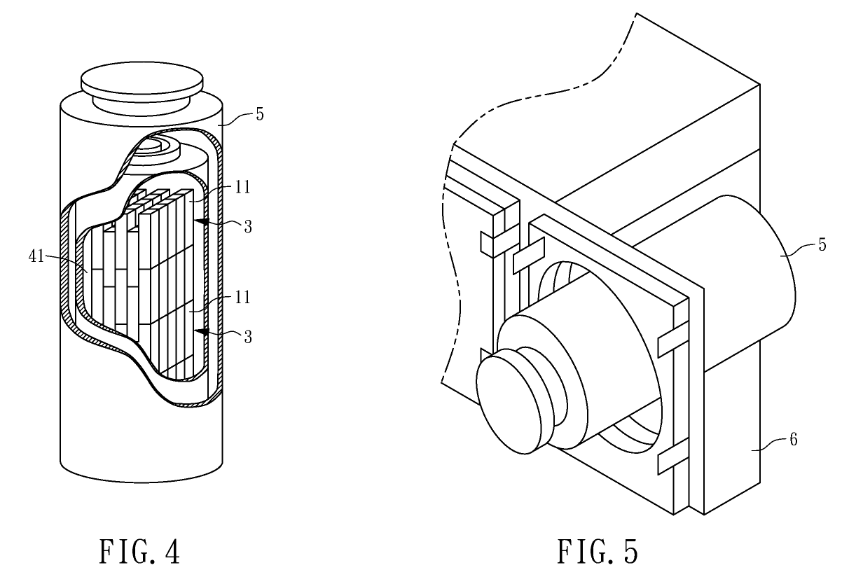

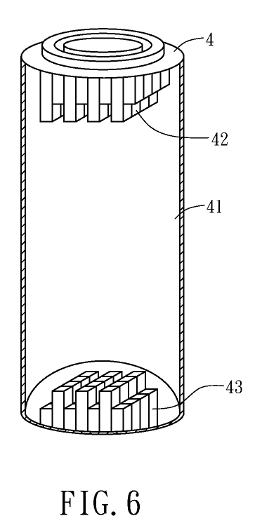

Please refer to FIG. 4 and FIG. 5, which are schematic diagrams showing respectively a dry storage of nuclear fuel according to an embodiment of the invention and how a dry storage of nuclear fuel of the invention is stored. In FIG. 4, the dry storage canister 4 is formed with a cavity 41 inside to be used for storing a plurality of nuclear fuel bundles 11. As shown in FIG. 6, there is a plurality of blocks of different heights being formed at the top and the bottom of the cavity 41 that each of the blocks, as the blocks 42 formed on the top and the blocks 43 formed on the bottom, are provided for one of the plural nuclear fuel bundles 11 to mounted fixedly thereon for enabling any neighboring nuclear fuel bundles in the tight formation to be ruggedly arranged with different heights, i.e. as the rugged formation shown in FIG. 3. In an embodiment of the invention, the blocks relating to the nuclear fuel bundles in the odd-numbered rows or columns of the formation are formed of a same specific height for aligning the odd-numbered nuclear fuel bundles to each other at the same height while the blocks relating to the nuclear fuel bundles in the even-numbered rows or columns of the formation are formed of another same specific height for aligning the even-numbered nuclear fuel bundles to each other at the same height; and the height difference between neighboring nuclear fuel bundles is ranged between 3 inches to 12 inches. The dry storage canister 4, being made of a metal, is received inside a metal container 5. Moreover, the dry storage canister 4 is stored on a rack 6 in a transverse manner along with its container 5. For conforming to regulations and safety requirements, the distances between neighboring nuclear fuel bundles 11 should be maintained in the dry storage canister 4 for preventing the critical safety problem relating to neutrons in spent nuclear fuel as well as heat dissipating problem from happening.

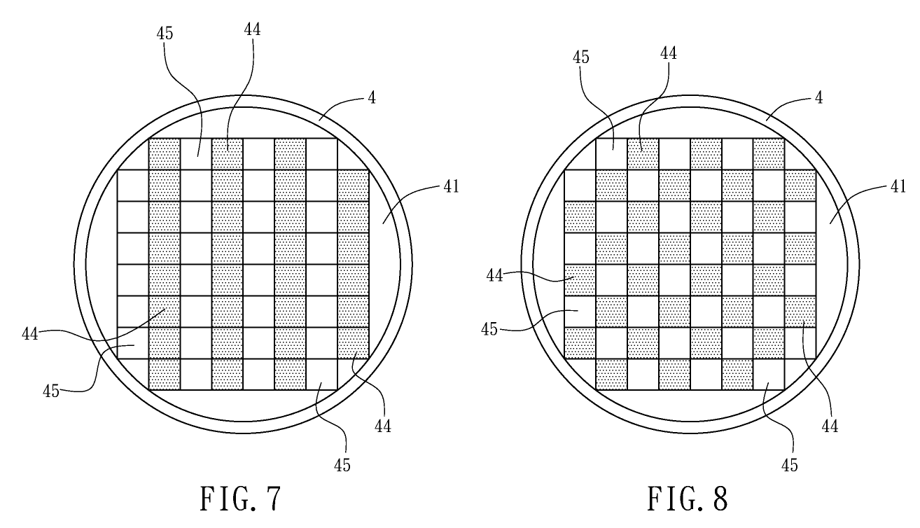

Please refer to FIG. 7 and FIG. 8, which are schematic diagrams showing how blocks are formed on the top and bottom in the cavity of a dry storage of nuclear fuel according to two different embodiments of the invention. As shown in FIG. 7 and FIG. 8, both the blocks formed on the top and the bottom in the dry storage canister 4 are substantially a grouping of high blocks 44 and low blocks 45 arranged alternatively in an array of various shapes. The blocks of FIG. 7 is arranged in an array similar to those shown in FIG. 6, but it is structured for enabling the blocks relating to the nuclear fuel bundles in the odd-numbered rows or columns of the formation to be high blocks 44 while enabling those of the even-numbered rows or columns to be low blocks 45. In FIG. 8, the high blocks 44 and low blocks are structured and arranged in a chessboard-like array in a manner that any one high block 44 is surrounded by low blocks 45 and any one low block 45 is surrounded by high blocks 44. It is noted that the storage safety using the configuration shown in FIG. 8 is higher than that of FIG. 7.

From the embodiments disclosed in FIG. 3˜FIG. 8, it is noted that the present invention provides a dry storage canister capable of arranging the nuclear fuel bundles stored therein in a rugged formation of different heights for reducing flux and effective multiplication factor of neutrons and thus causing the nuclear critical safety of the dry storage canister to be enhanced.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A dry storage of nuclear fuel, comprising:
a plurality of nuclear fuel bundles, being arranged in a tight formation;
a dry storage canister, formed with a cavity inside to be used for storing the plural nuclear fuel bundles;
wherein the cavity is formed with a plurality of blocks of different heights at the top and bottom thereof that each of the blocks on the top and bottom are provided for one of the plural nuclear fuel bundles to mounted fixedly thereon for enabling any neighboring nuclear fuel bundles in the tight formation to be ruggedly arranged with different heights.

2. The dry canister of claim 1, wherein the blocks relating to the nuclear fuel bundles in the odd-numbered rows or columns of the formation are formed of a same specific height for aligning the odd-numbered nuclear fuel bundles to each other at the same height while the blocks relating to the nuclear fuel bundles in the even-numbered rows or columns of the formation are formed of another same specific height for aligning the even-numbered nuclear fuel bundles to each other at the same height.

3. The dry canister of claim 1, wherein the plural blocks are substantially a grouping of high blocks and low blocks arranged in a chessboard-like array in a manner that any one high block is surrounded by low blocks and any one low block is surrounded by high blocks.

4. The dry canister of claim 1, wherein the height difference between neighboring nuclear fuel bundles is ranged between 3 inches to 12 inches.

5. The dry canister of claim 1, wherein the dry storage canister is made of a metal.

6. The dry canister of claim 1, wherein each of the plural nuclear fuel bundle is a fuel bundle selected from the group consisting of: a spent nuclear fuel bundle and an unused nuclear fuel bundle.

7. The dry canister of claim 1, wherein the dry storage canister is received inside a metal container.

8. The dry canister of claim 7, wherein the dry storage canister is stored on a rack in a transverse manner along with its container.
